(19) United States
(12) Patent Application Publication
(10) Pub. No.: US 2021/0301215 A1
(43) Pub. Date: Sep. 30, 2021

(54) HIGH VISCOSITY LUBRICANT FOR USE IN MACHINING METAL

(71) Applicant: Jesse Conner, Union Mills, NC (US)

(72) Inventor: Jesse Conner, Union Mills, NC (US)

(73) Assignee: Jesse Conner, Union Mills, NC (US)

(21) Appl. No.: 16/827,760

(22) Filed: Mar. 24, 2020

(51) Int. Cl. C10M 101/04; C10M 171/02; F16N 29/02

(52) U.S. Cl. CPC C10M 101/04; C10M 171/02; F16N 29/02; C10N 2240/406; C10N 2240/06; C10M 2207/40; C10N 2220/022

(57) ABSTRACT

A high viscosity lubricant and dispenser for use in machine work. In one example, the lubricant includes avocado oil and has a viscosity that allows it to be dispensed from a twist-up type, or other suitable dispenser as a paste, gel, or semi-solid. In another aspect, the lubricant includes wax to increase viscosity, the wax may be of any suitable type such as, for example, soy wax.

### BACKGROUND

The present disclosure relates generally to high viscosity lubricants that may be used in machining processes. Machining lubricants, also known as cutting fluids, are commonly introduced in the machining process to enhance the performance of machining parts. In general, lubricants reduce the heat and friction in the contact region between the machine tool and the work piece. They also assist in work piece chip removal, reduce the likelihood of tip welding, reduce or eliminate oxidation, increase the lifetime of the working tool, and allow for a more accurately manufactured work piece.

Many machining lubricants are liquid based which allows them to be easily sprayed onto the contact region to cool and lubricate the cutting tool. To be delivered in this manner, the lubricant usually has a low viscosity. The low viscosity of the lubricant also means that the lubricant can quickly transition through the contact region and drain away thus requiring additional lubricant to be applied. Additionally, applying the lubricant as a spray means a significant quantity of lubricant is never applied to the contact area and is thus wasted. Also, some lubricants include chemicals that are harmful. Prolonged exposure to cutting fluids may result in skin disorders, respiratory problems, and even cancer. Spraying the lubricant makes this unwanted exposure more likely as much of the lubricant is lost into the air and applied to surrounding surfaces.

### SUMMARY

Disclosed is a high viscosity lubricant for use in machine work. In one example, the lubricant includes avocado oil which is a naturally occurring plant product that can also provide lubricity at higher temperatures. In another aspect the lubricant may include over 20% avocado oil. In another aspect, the lubricant has a viscosity that allows it to be dispensed as a paste, gel, or semi-solid. In another aspect, the lubricant includes wax to increase viscosity, the wax may be of any suitable type such as, for example, paraffin based wax or, more preferably, soy wax.

Soy wax as used herein may include between 50% and 100% of high melting point soy wax and between 0% and 50% of low melting point soy wax, provided that the total of them is 100%. In another aspect, part of the soy wax, preferably not more than 50%, may be replaced by other waxes of natural origin, such as, for example, beeswax or carnauba wax, or other waxes derived from the hydrogenation of various vegetable oils such as palm oil, corn oil, sunflower oil, peanut oil, olive oil or cottonseed oil, among others.

In another aspect, the high-viscosity lubricant may be applied as a paste, gel, or semi-solid to the inside of a hole, groove, or other negative space defined by a work part. For example, the lubricant may be applied to a hole while machining threads in metal. In another aspect, the lubricant may be free of water.

In another aspect, the lubricant may be dispensed from a rigid tubular applicator as a semi-solid or paste. The applicator may optionally be a twist-up type where the lubricant projects outwardly from the tube when a portion of the tube is rotated.

In another aspect, the lubricant composition may include over 75% emollient carriers, and may optionally include boric acid to reduce flammability. In another aspect, the lubricant may be produced by combining emollient carriers and avocado oil at between 100 and 180 degrees Fahrenheit. In one example, the emollient carriers and avocado oil are combined at about 140 degrees Fahrenheit. In another aspect, the lubricant may optionally be used with any of the following material types aluminum, brass, carbide, cast iron, copper, fiberglass, glass, iron, nickel, plastic, rubber, stone, stainless steel, steel, and/or titanium, or any combination thereof.

In another aspect, disclosed is a lubrication device that includes a container having a closed end and an open end, the open end selectively covered by a cap. The lubrication device may also include an actuator assembly having a rotating member outside the container, and a lubricant inside the container, the lubricant optionally having a mixture of avocado oil and soy wax that has a high viscosity at room temperature of at least 1×10\hat{ }4 centipoise.

In another aspect, the lubricant may be coupled to the actuator assembly and retained within the container by virtue of the actuator assembly and high viscosity of the lubricant. In another aspect, the actuator assembly may be arranged and configured to selectively extend or retract the lubricant from the container.

In another aspect, the wax includes, or is predominantly, a soy wax. In another aspect, the lubricant may include over 20% avocado oil by weight. In another aspect, the lubricant includes over 75% emollient carriers by weight. In another aspect, the lubricant further includes boric acid to reduce flammability. In another aspect, the emollient carriers optionally include soy wax. In another aspect, the soy wax optionally has a melting point that is above 50 degrees centigrade. In another aspect, the lubricant includes at least 40% avocado oil by weight to increase temperature resistance. In one example, the lubricant includes at least 20% avocado oil by weight, at least 75% emollient carriers, and the emollient carriers optionally include soy wax.

In another example the actuator assembly includes a plunger that engages the lubricant. The rotating member optionally extends into the container and engages the plunger. In another aspect, the plunger is optionally configured to move inside the container toward the open end when the rotating member is rotated in a first direction, and toward the closed end when rotated in a second direction opposite the first direction. In another aspect, the cap is coupled to the open end of the container. In another aspect, the lubricant has a high viscosity of at least 1×10\hat{ }8 centipoise at room temperature.

In another aspect, disclosed is a method of using the lubrication device which includes opening the cap to expose the open end of the container, optionally engaging the rotating member to extend an exposed portion of the lubricant from the open end of the container, and applying the exposed portion of the lubricant to a work piece. In another aspect, the lubricant is optionally oriented vertically with the exposed portion directed downward into the hole when the lubricant is applied to the work piece. In another aspect, the work piece includes aluminum, brass, carbide, cast iron, copper, fiberglass, glass, iron, nickel, plastic, rubber, stone, stainless steel, steel, and/or titanium, or any combination thereof.

In another aspect, the ingredients used in the disclosed high-viscosity lubricant are eco-friendly and sustainable. Preferably, the lubricant is free of known carcinogens and includes carbon neutral and sustainable materials. In another aspect, the lubricant container includes bio-degradable compounds.

The system and techniques as described and illustrated herein concern a number of unique and inventive aspects. Some, but by no means all, of these unique aspects are summarized below.

### BRIEF DESCRIPTION OF THE DRAWINGS

FIG. 1 is a cross-sectional view of one example of the disclosed applicator for a high viscosity lubricant.

FIG. 2 is an exploded view of the lubricant applicator of FIG. 1.

FIG. 3 is a schematic view of the disclosed lubricant applicator in use.

FIG. 4 is a chart comparing performance of the disclosed lubricant during heating.

### DETAILED DESCRIPTION

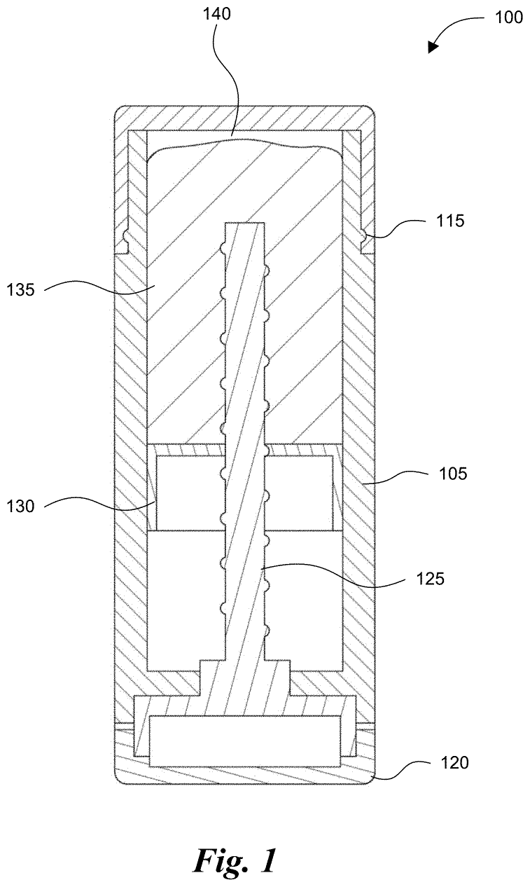

FIG. 1 illustrates one example of the disclosed lubricant compound in an applicator. In FIG. 1 is shown a cross-sectional view of a twist-up type applicator 100. The applicator 100 includes a housing 105 for housing a high-viscosity lubricant 135, and a cap 110 positioned over one open end 140 of the housing to protect the lubricant from intrusion by debris. Also included is an actuator 120 configured to interact with the container to extend or retract a high-viscosity lubricant 135. In one example, the housing 105 and the cap 110 couple together via a snap fit connection facilitated by protrusion 115 projecting outwardly from the wall of the container, and a corresponding indention in the cap 110.

Any suitable couple mechanism for the cap may be used. In another example, the cap 110 is coupled to the housing 105 with a threaded connection. In another example, the cap is coupled to the housing and selectively movable away from the opening 140 while still coupled to the housing.

In another aspect, the actuator 120 may be rotated clockwise and/or counter clockwise direction to move a threaded portion 125 that extends into the container and the lubricant. The rotational movement of the threaded portion 125 causes a riser 130 to move within the container either toward or away from the open end 140. In one example, the clockwise rotation of the actuator 120 may result in clockwise rotation of the threaded portion 125. This rotational movement may then cause movement of the riser 130 which in turn may result in movement of the lubricant 135 either toward or away from the opening 140. The threaded portion 125 may also retain the lubricant 135 within housing 105 regardless of whether the housing 105 is rotated in any angle or direction relative to gravity. For example, the housing may be held vertically with the opening 140 directed downward with respect to gravity, or in any position in between without the lubricant 135 coming free and separating from the housing.

As for the composition, the lubricant 135 may include a mixture of soy wax and avocado oil in a semi-solid state. In one example, the lubricant includes at least 20% avocado oil by weight and at least 75% by weight emollient carriers such as soy wax. The mixture of avocado oil and emollient carriers creates a high viscosity lubricant of at least 1×10\hat{ }4 centipoise. In another example, the mixture includes 40% avocado oil by weight, and about 25% soy wax by weight. This configuration may provide additional temperature resistance. In another aspect, the lubricant components are mixed together between 100-180 degrees Fahrenheit. Mixing the ingredients at these temperatures may optionally provide for efficient bonding of the component chemicals.

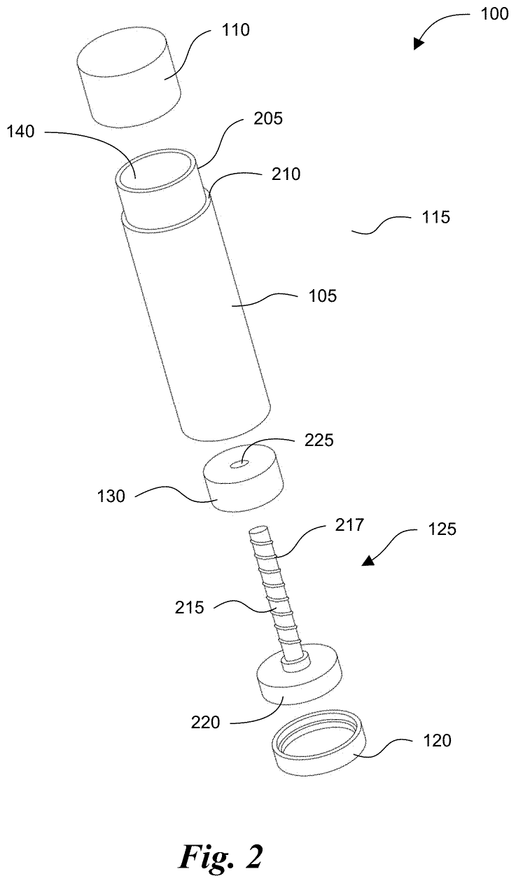

FIG. 2 illustrates an exploded view of the applicator 100 of FIG. 1. The housing 105 includes a reduced diameter portion 205 and a lip 210. The reduced diameter portion 205 defines opening 140 and provides a location where the lubricant 135 extends from the applicator 100. The lip 210 serves as a stop for the cap 110. For example, the cap 110 may be configured to slide over and around the reduced diameter portion 205 to finally abut the lip 210. The threaded portion 125 may include a shaft 215 coupled to a shaft base 220. The shaft 215 may further include one or more threads 217. The shaft 215 may be configured to fit through an aperture 225 defined by riser 130. The aperture 225 may include interior threads configured to engage with the threads 217 of the shaft 215, to control the vertical movement of the lubricant 135. The shaft 215 is coupled to shaft base 220 so as to rotate relative to the riser 130 and lubricant 135. Threads 217 interact with internal threads of the riser 130 thus translating rotation of the actuator into linear motion of the riser 130.

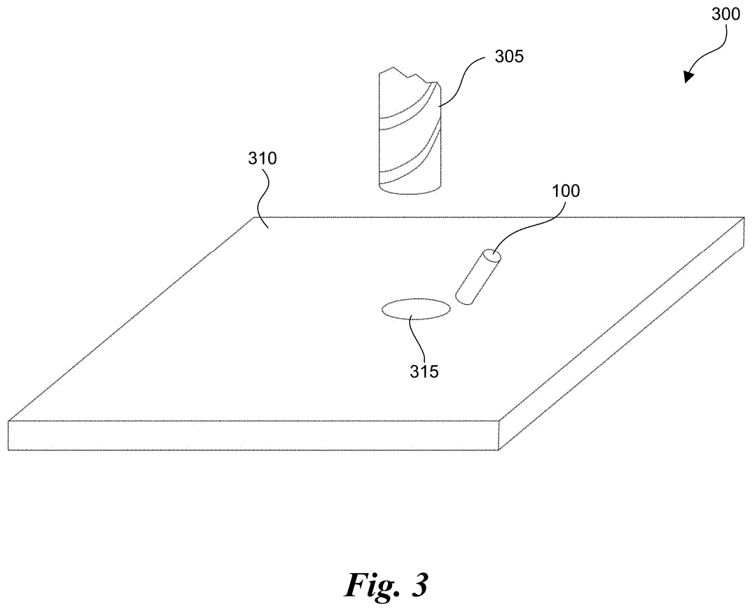

In another aspect, the lubricant may be used to lubricate a machine tool during a machining process. An example of this in operation is illustrated in FIG. 3. For example, the cap 110 is removed from the housing 105, the reduced diameter portion 205 is now exposed. At the opposite end from the cap 110, the actuator 120 is rotated in the clockwise direction causing the high-viscosity lubricant to extend outwardly through opening 140. Because the lubricant is a semi-solid or paste with a high viscosity, the lubricant can be applied to a work piece 310 at a contact region 315, and/or to a machine tool 305. This application may occur at any angle relative to gravity. The housing 105 can, for example, be angled downward without the lubricant 135 uncontrollably escaping from the housing. Specific quantities of the lubricant may then be applied by physically contacting the work piece or the machine tool with portions of the lubricant applied to the location where it is most needed. After the lubricant 135 is applied, the actuator 120 may be rotated counter clockwise to move riser 130 away from opening 140 until the lubricant 135 is within housing 105.

In one example, the tool 305 is a CNC machine. In alternate embodiments the tool 305 may be a power tool, a hand tool, a grinding tool, a cutting tool, a milling tool, a lathe, and/or any other tool that may be used to shape or work a material. The work piece 310 may be any suitable material of interest that is being modified by the tool 305. In one example, the work piece 310 is aluminum. In alternate embodiments the work piece 310 may be brass, carbide, cast iron, copper, fiberglass, glass, iron, nickel, plastic, rubber, stone, stainless steel, steel, titanium, and/or any other material in need of modification.

The tool 305 may contact the work piece 310 at the contact region 315 where the tool 305 interacts with the work piece 310. The contact region 315 may be the area of greatest friction and thus the region where heat and friction are most prevalent and the need for lubricant 135 is the greatest.

In one example, the applicator 100 may be used to apply lubricant 135 to the contact region 315 parallel with the work piece 310. In this example, the lubricant is applied to the tool or work piece, or both, thus optionally providing a lubricating film on the tool 305 and/or the work piece. The high viscosity of the lubricant 135 thus allows the lubricant to maintain position on the tool 305 without immediately leaking away.

In another example, the lubricant 135 is applied continuously to the contact region 315 at an angle of roughly 45 degrees relative to the tool, such as in the case of applying a threading tap to a hole. The 45-degree angle of incidence may allow the lubricant 135 to enter the contact region 315 and maintain the proper temperature and lubrication levels throughout the machining process. In a further example, the lubricant 135 is applied to the contact region 315 perpendicular with the work piece 310. This method allows the lubricant 135 to fill the contact region 315 with lubricant 135. It should be appreciated that the high viscosity of the lubricant 135 allows for a variety of application methods and angles. The lubricant 135 may be applied at any suitable angle relative to the tool 305 or the work piece 310.

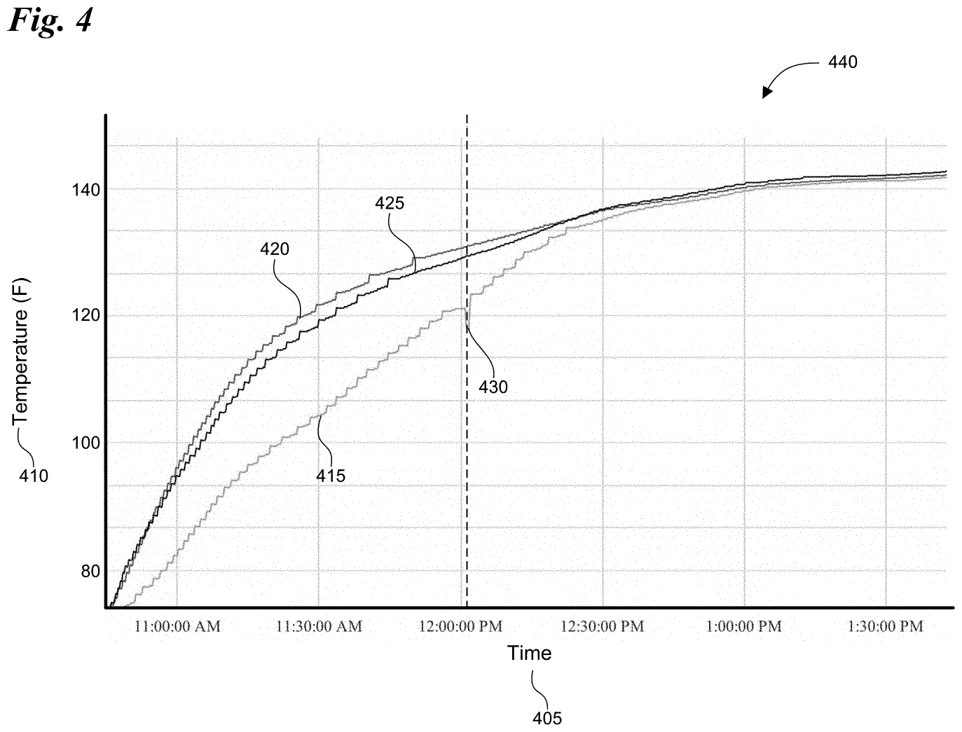

FIG. 4 shows a graph 400 of the temperature change for the disclosed lubricant as it changes temperature when subjected to 158 degrees Fahrenheit ambient temperature, and provides for the comparison between the disclosed High Viscosity Lubricant (HVL) 135 and two other lubricants—a Modern Cutting Oil (MCO) and an All Purpose Oil (APO). The graph 400 includes an x-axis depicting the passage of time at 405 and a y-axis depicting different temperatures at 410. The graph 400 illustrates the change in temperature for the disclosed HVL at 415, which represents the change in temperature over time of the disclosed high-viscosity lubricant 135 as it is subjected to steady heating at 158 degrees Fahrenheit. Graph 400 also illustrates the change in temperature for a MCO and an APO at 420 and 425 respectively. Both 420 and 425 represent the change in temperature over time for the MCO and APO lubricants thus providing a comparison of how quickly the different lubricants change temperature when subjected to steady heating at 158 degrees Fahrenheit.

The HVL undergoes a phase change at 430 at approximately 120 F. The phase change 430 represents a change in state of the lubricant 135 from a solid to a liquid. In the solid phase at 435, the lubricant is in the semi-solid state with a high viscosity. As the lubricant warms, it becomes less viscous until it reaches the phase change 430 where the lubricant 135 transitions to a more liquid state at 440.

Comparing the curves of the HVL at 415 with the MCO at 420, and the APO at 425 illustrates how the HVL advantageously performs under heating. Notably, for example, the MCO at 420 and the APO at 425 show an exponential increase in temperature with time, while the HVL at 415 shows a more linear, or approximately linear, rate of increase thus maintaining the structural integrity of the high-viscosity lubricant longer and under higher temperatures. This advantageously provides for better control of the application of the lubricant as the work piece and cutting tool become warmer during a machining process.

Combining the information from graph 400 and graph 500 gives insight into the bounds of the semi-solid state of the lubricant 135. For example, the lubricant remains in the semi-solid state from −24 F to 120 F. This wide temperature span allows the lubricant to be at a high viscosity for most machining and/or tapping applications. As has been discussed previously, the semi-solid, high viscosity of the lubricant 135 allows the lubricant 135 to be applied to the working region from a variety of angles and with a variety of lubrication methods.

Other examples of the disclosed concepts include the following numbered examples:

### Example 1

A lubrication device, including a container, and a lubricant inside the container, the lubricant having a mixture of avocado oil and soy wax that has a high viscosity at room temperature of at least 1×10\hat{ }4 centipoise.

### Example 2

Any preceding example, wherein the wax is a soy wax.

### Example 3

Any preceding example, wherein the lubricant includes over 20% avocado oil by weight.

### Example 4

Any preceding example, wherein the lubricant includes over 75% emollient carriers by weight.

### Example 5

Any preceding example, wherein the lubricant further includes boric acid to reduce flammability.

### Example 6

Any preceding example, wherein the emollient carriers include soy wax.

### Example 7

Any preceding example, wherein the soy wax has a melting point that is above 50 degrees centigrade.

### Example 8

Any preceding example, wherein the lubricant includes at least 40% avocado oil by weight to increase temperature resistance.

### Example 9

Any preceding example, the lubricant includes at least 20% avocado oil by weight, at least 75% emollient carriers, and wherein the emollient carriers include soy wax.

### Example 10

Any preceding example, wherein the device includes an actuator assembly that has a plunger that engages the lubricant, wherein the rotating member extends into the container and engages the plunger, and wherein the plunger is configured to move inside the container toward the open end when the rotating member is rotated in a first direction, and toward the closed end when rotated in a second direction opposite the first direction.

### Example 11

Any preceding example, wherein the cap is coupled to the open end of the container.

### Example 12

Any preceding example, wherein the lubricant has a high viscosity of at least 1×10\hat{ }8 centipoise at room temperature.

### Example 13

A method of using a lubrication device of any preceding example that includes opening a cap to expose the open end of the container, engaging a rotating member to extend an exposed portion of the lubricant from the open end of the container, and applying the exposed portion of the lubricant to a work piece.

### Example 14

The method of any preceding method example, wherein the work piece defines a hole, and wherein the lubricant is oriented vertically with the exposed portion directed downward into the hole when the lubricant is applied to the work piece.

### Example 15

The method of any preceding method example, wherein the work piece includes aluminum, brass, carbide, cast iron, copper, fiberglass, glass, iron, nickel, plastic, rubber, stone, stainless steel, steel, and/or titanium, or any combination thereof.

### Example 16

The device of any preceding example, wherein the container defines a closed end and an open end, the open end selectively covered by a cap

### Example 17

The device of any preceding example, including an actuator assembly having a rotating member outside the container

### Example 18

The device of any preceding claim, wherein the lubricant is coupled to an actuator assembly and retained within the container by virtue of the actuator assembly and high viscosity of the lubricant.

### Example 19

The device of any preceding claim, wherein the container includes an actuator assembly arranged and configured to selectively extend or retract the lubricant from the container.

### Glossary of Definitions and Alternatives

While examples of the inventions are illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the inventions. No limitation of the scope of the inventions is thereby intended. Any alterations and further modifications in the described examples, and any further applications of the principles described herein are contemplated as would normally occur to one skilled in the art to which the inventions relate. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“Actuator” generally refers to a device that causes a machine or other device to move. Actuators may be mechanical, electrical, hydraulic, and/or pneumatic. An example of a mechanical actuator is a jack screw. A jack screw consists of a heavy-duty vertical screw with a load table mounted on its top, which screws into a threaded hole in a stationary support frame with a wide base resting on the ground. A rotating collar on the head of the screw has holes into which the handle, a metal bar, fits. When the handle is turned clockwise, the screw moves further out of the base, lifting the load resting on the load table. In order to support large load forces, the screw usually has either square threads or buttress threads.

“Centipoise” generally refers to a unit of measure for dynamic viscosity. One centipoise is equal to one millipascal second. For example, water is 1 centipoise whereas peanut butter is about 250,000 or about 2.5×10\hat{ }5 centipoise.

“Dispenser” generally refers to a container, package, device, or machine for holding and dispensing a substance or substances in quantities which may, or may not be, of a fixed or predetermined size. Examples include twist-up type dispensers, collapsible tubes (e.g. for toothpast), metered dispensers, and the like.

“Lubrication” generally refers to the process or technique of using a lubricant to reduce friction and/or wear and tear between two surfaces in contact. Lubricants include solids, semi-solids, liquids, and/or gasses. Examples include grease, water, oil, wax, and/or any other material with a low friction value. The goals of lubrication are to reduce friction, reduce wear, protect equipment from corrosion, dissipate heat, provide a seal, and/or reduce contamination.

Types of lubrication include full-film lubrication, boundary lubrication, and mixed lubrication. Full-film lubrication may be broken into two types hydrodynamic and elastohydrodynamic. Hydrodynamic lubrication occurs when two surfaces in sliding motion relative to each other are fully separated by a film of fluid. Elastohydrodynamic lubrication occurs when the surfaces are in rolling motion relative to each other. The film layer is much thinner than in hydrodynamic lubrication, and the pressure on the film is greater. Boundary lubrication is found in conditions with frequent starts and stops. In this lubrication type, only the anti-wear additives and/or extreme-pressure additives are protecting the material. This is not ideal as friction is high. Mixed lubrication is a cross between boundary and hydrodynamic lubrication. In this type the bulk of the surfaces are separated by a lubricating layer, but the asperities still come into contact with each other.

“Lubrication Device” generally refers to a device used apply lubricant. The device may be configured to work with solid, semi-solid, liquid, and/or gaseous lubricants.

“Melting Point” generally refers to the temperature at which a substance changes state from a solid to a liquid. The melting point is dependent on the material in question. For example, the melting point of water is 0 degrees Celsius. Whereas the melting point of paraffin wax is 37 degrees Celsius.

“Snap-Fit Connector” or “Snap-Fit Connection” generally refers to a type of attachment device including at least two parts, with at least one of which being flexible, that are interlocked with one another by pushing the parts together. The term “Snap-Fit Connector” may refer to just one of the parts, such as either the protruding or mating part, or both of the parts when joined together. Typically, but not always, the snap-fit connector includes a protrusion of one part, such as a hook, stud and/or bead, that is deflected briefly during the joining operation and catches in a depression and/or undercut in the mating part. After the parts are joined, the flexible snap-fit parts return to a stress-free condition. The resulting joint may be separable or inseparable depending on the shape of the undercut. The force required to separate the components can vary depending on the design.

By way of non-limiting examples, the flexible parts are made of a flexible material such as plastic, metal, and/or carbon fiber composite materials. The snap-fit connectors can include cantilever, torsional and/or annular type snap-fit connectors. In the annular snap-fit type connector, the connector utilizes a hoop-strain type part to hold the other part in place. In one form, the hoop-strain part is made of an elastic material and has an expandable circumference. In one example, the elastic hoop-strain part is pushed onto a more rigid part so as to secure the two together. Cantilever snap-fit type connectors can form permanent type connections or can be temporary such that the parts can be connected and disconnected multiple times. A multiple use type snap-fit connector typically, but not always, has a lever or pin that is pushed in order to release the snap-fit connection. For a torsional snap fit connector, protruding edges of one part are pushed away from the target insertion area, and the other part then slides in between the protruding edges until a desired distance is reached. Once the desired distance is reached, the edges are then released such that the part is held in place.

“Tool” generally refers to a device or implement used for a particular function. Some examples are power tool, hand tools, outdoor tools, indoor tools, milling tools, cutting tools, grinding tools, boring tools, and/or autonomous tools.

“Viscosity” generally refers to a measure of a fluids resistance to deformation at a given rate. A fluid that has a low viscosity has little resistance to shear stress. For example, water. A fluid with a high viscosity has a larger resistance to shear stress. For example, syrup. A fluid with no resistance to shear stress is known as an ideal or inviscid fluid. This is only observed at very low temperatures in superfluid's such as liquid helium. Dynamic viscosity is measured in Pascal-seconds in the SI system and is measured in poise or centipoise in the centimeter-gram-second measurement system.

“Wax” generally refers to a lipophilic organic compound that presents as a malleable solid near ambient temperatures and may include alkanes and lipids. Waxes commonly have melting points above about 40 degrees Centigrade (about 104 degrees Fahrenheit) at which point they are commonly a low viscosity liquids. Waxes are commonly insoluble in water but soluble in organic, nonpolar solvents. Examples of include:

Animal Waxes

Waxes produced by animals, or created from animal byproducts. Beeswax is a well-known example of animal wax used by bees in constructing honeycombs. A major component of the beeswax is myricyl palmitate which is an ester of triacontanol and palmitic acid. Its melting point is 62-65 degrees Centigrade.

Another example of animal wax is spermaceti which occurs in large amounts in the head oil of the sperm whale. Raw spermaceti is liquid within the head of the sperm whale and is composed mostly of wax esters (chiefly cetyl palmitate) and a smaller proportion of triglycerides. Most of the carbon chains in the wax esters are relatively long (C10-C22). In another related example, the blubber oil of the whale is about 66% wax. When it cools to 30 degrees Centigrade or below, the waxes begin to solidify. Spermaceti is insoluble in water, very slightly soluble in cold ethanol, but easily dissolved in ether, chloroform, carbon disulfide, and boiling ethanol. Lanolin is a wax obtained from wool, consisting of esters of sterols.

### Plant Waxes

Plants secrete waxes into and on the surface of their cuticles as a way to control evaporation, wettability and hydration. The epicuticular waxes of plants are mixtures of substituted long-chain aliphatic hydrocarbons, containing alkanes, alkyl esters, fatty acids, primary and secondary alcohols, diols, ketones, aldehydes. One common plant wax is carnauba wax, a hard wax obtained from the Brazilian palm Copernicia prunifera. Containing the ester myricyl cerotate, it has many applications, such as confectionery and other food coatings, car and furniture polish, floss coating, and surfboard wax. Other more specialized vegetable waxes include jojoba oil, candelilla wax and ouricury wax.

### Modified Plant and Animal Waxes

Plant and animal based waxes or oils can undergo selective chemical modifications to produce waxes with more desirable properties than are available in the unmodified starting material. This approach has relied on green chemistry approaches including olefin metathesis and enzymatic reactions and can be used to produce waxes from inexpensive starting materials like vegetable oils.

### Petroleum Derived Waxes

Although many natural waxes contain esters, paraffin waxes are hydrocarbons, mixtures of alkanes usually in a homologous series of chain lengths. These materials represent a significant fraction of petroleum. They are often refined by vacuum distillation. Paraffin waxes are mixtures of saturated n- and iso-alkanes, naphthenes, and alkyl- and naphthene-substituted aromatic compounds. A typical alkane paraffin wax chemical composition comprises hydrocarbons with the general formula CnH2n+2, such as hentriacontane, C31H64. The degree of branching has an important influence on the properties. Microcrystalline wax is a lesser produced petroleum based wax that contains higher percentage of isoparaffinic (branched) hydrocarbons and naphthenic hydrocarbons. Paraffin waxes are common with millions of tons produced annually. They are used in foods (such as chewing gum and cheese wrapping), in candles and cosmetics, as non-stick and waterproofing coatings and in polishes.

### Montan Wax

Montan wax is a fossilized wax extracted from coal and lignite. It is very hard, reflecting the high concentration of saturated fatty acids and alcohols. Although dark brown and odorous, they can be purified and bleached to give commercially useful products.

### Polyethylene and Related Derivatives

Polyethylene waxes are manufactured by methods that include direct polymerization of ethylene (may include co-monomers also), thermal degradation of high molecular weight polyethylene resin, and recovery of low molecular weight fractions from high molecular weight resin production. Each production technique generates products with slightly different properties. Key properties of low molecular weight polyethylene waxes are viscosity, density and melt point.

Polyethylene waxes produced by means of degradation or recovery from polyethylene resin streams contain very low molecular weight materials that must be removed to prevent volatilization and potential fire hazards during use. Polyethylene waxes manufactured by this method are usually stripped of low molecular weight fractions to yield a flash point greater than 500 degrees Fahrenheit (greater than 260 degrees Centigrade). Many polyethylene resin plants produce a low molecular weight stream often referred to as Low Polymer Wax (LPW). LPW is unrefined and contains volatile oligomers, corrosive catalyst and may contain other foreign material and water. Refining of LPW to produce a polyethylene wax involves removal of oligomers and hazardous catalyst. Proper refining of LPW to produce polyethylene wax may be ueful when being used in applications requiring Food and Drug Administration (FDA) or other regulatory certification.

### Soy Wax

Soy wax generally refers to wax that is made by the full hydrogenation of soybean oil. This full hydrogenation gives a triglyceride containing a high proportion of stearic acid. It is typically softer than paraffin wax and with a lower melting temperature, in most combinations. However, additives can raise this melting point to temperatures typical for paraffin-based candles.

The triglycerides are esters of fatty acids and glycerol, in which the three hydroxyl groups of glycerol are esterified. The main factors that determine whether a triglyceride is solid or liquid at room temperature are the degree of saturation or unsaturation of the fatty acids that constitute it, as well as their chain length. In general, the higher are the saturation degree and the length of the triglyceride's fatty acids chain, the higher is its melting point.

Soy oil mainly contains a mixture of triglycerides, mainly mono- or polyunsaturated, the majority being derived from linoleic, oleic, and alpha-linolenic acid. One can distinguish different types of soy wax according to its degree of hydrogenation, which in turn determines its melting point, so that, the greater the hydrogenation the higher the melting point is.

Soy wax can be classified into high melting point soy wax and low melting point soy wax. High melting point soy wax generally has a melting point is above 50° C., while low melting point soy wax has a melting point that is 50° C. or lower. The melting point ranges from 49 to 82 degrees Celsius (120 to 180 degrees Fahrenheit), depending on the presence of other chemicals combined with it. The density of soy wax is about 90% that of water or 0.9 g/ml. Soy wax is available in flake and pellet form and has an off-white, opaque appearance.

### REFERENCE NUMBERS

100 applicator
105 housing
110 cap
115 snap fit
120 actuator
125 threaded portion
130 riser
135 lubricant
140 opening
205 reduced diameter portion
210 lip
215 shaft
217 threads
220 shaft base
225 aperture
300 lubrication method
305 tool
310 work piece
315 contact region
400 graph
405 time
410 temperature
415 AOSW plot
420 MDCO plot
425 APO plot
430 phase change
435 solid phase
440 liquid phase

What is claimed is:

1. A lubrication device, comprising:
a container having a closed end and an open end, the open end selectively covered by a cap;
an actuator assembly having a rotating member outside the container; and
a lubricant inside the container, the lubricant having a mixture of avocado oil and soy wax that has a high viscosity at room temperature of at least 1×10\hat{ }4 centipoise;
wherein the lubricant is coupled to the actuator assembly and retained within the container by virtue of the actuator assembly and high viscosity of the lubricant; and
wherein the actuator assembly is arranged and configured to selectively extend or retract the lubricant from the container.

2. The lubrication device of claim 1, wherein the wax is a soy wax.

3. The lubrication device of claim 1, wherein the lubricant includes over 20% avocado oil by weight.

4. The lubrication device of claim 1, wherein the lubricant includes over 75% emollient carriers by weight.

5. The lubrication device of claim 1, wherein the lubricant further includes boric acid to reduce flammability.

6. The lubrication device of claim 4, wherein the emollient carriers include soy wax.

7. The lubrication device of claim 6, wherein the soy wax has a melting point that is above 50 degrees centigrade.

8. The lubrication device of claim 1, wherein the lubricant includes at least 40% avocado oil by weight to increase temperature resistance.

9. The lubrication device of claim 1, the lubricant includes
at least 20% avocado oil by weight;
at least 75% emollient carriers; and
wherein the emollient carriers include soy wax.

10. The lubrication device of claim 1, wherein the actuator assembly includes
a plunger that engages the lubricant;
wherein the rotating member extends into the container and engages the plunger;
wherein the plunger is configured to move inside the container toward the open end when the rotating member is rotated in a first direction, and toward the closed end when rotated in a second direction opposite the first direction.

11. The lubrication device of claim 1, wherein the cap is coupled to the open end of the container.

12. The lubrication device of claim 1, wherein the lubricant has a high viscosity of at least 1×10\hat{ }8 centipoise at room temperature.

13. A method of using the lubrication device of claim 1, comprising:
opening the cap to expose the open end of the container;
engaging the rotating member to extend an exposed portion of the lubricant from the open end of the container;
applying the exposed portion of the lubricant to a work piece.

14. The method of claim 13, wherein the work piece defines hole, and wherein the lubricant is oriented vertically with the exposed portion directed downward into the hole when the lubricant is applied to the work piece.

15. The method of claim 13, wherein the work piece includes aluminum, brass, carbide, cast iron, copper, fiberglass, glass, iron, nickel, plastic, rubber, stone, stainless steel, steel, and/or titanium, or any combination thereof.
